(19) United States
(12) Patent Application Publication
(10) Pub. No.: US 2022/0339913 A1
(43) Pub. Date: Oct. 27, 2022

(54) SELF-HEALING SEALING DEVICE

(71) Applicant: SIKA TECHNOLOGY AG, Baar (CH)

(72) Inventors: Shenghua XU, Shanghai (CN); Wilfried CARL, Wädenswil (CH); Blaise LEEBER, Burlington, MA (US); Matthias VILLIGER, Alpnach Dorf (CH)

(73) Assignee: SIKA TECHNOLOGY AG, Baar (CH)

(21) Appl. No.: 17/764,099

(22) PCT Filed: Nov. 25, 2020
(86) PCT No.: PCT/EP2020/083429

§ 371 Date: Mar. 25, 2022

(30) Foreign Application Priority Data
Nov. 25, 2019 (CN) PCT/CN2019/120643

(51) Int. Cl. B32B 25/14; B32B 27/32; B32B 27/30; B32B 27/18

(52) U.S. Cl. CPC B32B 25/14; B32B 27/322; B32B 27/306; B32B 27/304; B32B 27/18; B32B 2307/762; B32B 2307/50

(57) ABSTRACT

A sealing device including a first polymeric layer, a second polymeric layer, and a third polymeric layer, the second polymeric layer located between the first and third polymeric layers and including at least one polymer and at least one powdered superabsorber polymer. Also, a method for producing a sealing device and a method for covering a substrate using the sealing devices.

### TECHNICAL FIELD

The invention relates to industrial liners, such as waterproofing and roofing membranes.

### BACKGROUND OF THE INVENTION

In the field of construction polymeric sheets, which are often referred to as membranes or panels, are used to protect underground and above ground constructions, such as basements, tunnels, and flat and low-sloped roofs, against penetration of water. Waterproofing membranes are applied, for example, to prevent ingress of water through cracks that develop in the concrete structure due to building settlement, load deflection or concrete shrinkage. Roofing membranes used for waterproofing of flat and low-sloped roof structures are typically provided in form of single-ply or multi-ply membrane systems. A single-ply roofing membrane comprises a single waterproofing layer, which is typically mechanically stabilized with a reinforcement layer, such as a layer of non-woven fabric and/or a reinforcing scrim. Multi-ply roofing membranes comprise two or more waterproofing layers, which can have same or different compositions. Single-ply roofing membranes have the advantage of lower production costs compared to the multi-ply membranes but they are also less resistant to mechanical damages caused by punctures of sharp objects.

Commonly used materials for waterproofing and roofing membranes include plastics, in particular thermoplastics such as plasticized polyvinylchloride (p-PVC), thermoplastic olefin elastomers (TPE-O), and elastomers such as crosslinked ethylene-propylene diene monomer rubber (EPDM). Thermoplastic olefin elastomers (TPE-O), also known as thermoplastic polyolefins (TPO), are specific types of heterophasic polyolefin systems. These are typically blends of a high-crystallinity “base polyolefin”, typically having a melting point of 100° C. or more, and a low-crystallinity or amorphous “polyolefin modifier”, typically having a glass transition temperature of −20° C. or less. The heterophasic phase morphology consists of a matrix phase composed primarily of the base polyolefin and a dispersed phase composed primarily of particles of the polyolefin modifier.

Waterproofing and roofing membranes are typically delivered to a construction site in form of rolls, unrolled, and cut into suitable pieces to be adhered on the surface of the substrate to be waterproofed. Especially the polymeric single-ply membranes but also the multi-ply membranes have a relatively low resistance against mechanical impacts caused by sharp objects falling on the surface of the membrane. Damaging of a membrane may occur, for example, during the construction or inspection phases. A membrane may, for example, be damaged as a result of a carelessly conducted cutting operation. Damages may also be generated by extensive traffic across the roof surface or by storing of heavy equipment on the roof, for example, during façade cleaning. Finally, a roofing membrane may be damaged due to a naturally occurring phenomena, such as a result of hailstone impacts.

When a leakage in the membrane is discovered, the repair typically consists of patching the opening and thereby leaving the moisture trapped in the system. In a typical adhered roof system, the trapped moisture will degrade the adhesive bond and/or the cohesive strength of the top surface of the insulation or cover board below causing localized delamination of the assembly and making the roof susceptible to significant damage under wind load. Furthermore, small breaches in membranes are often difficult to localize and in many cases the leakage is discovered only after the water has already caused significant damage to the building structures. It would, therefore, be desired to provide a membrane having improved resistance against mechanical impacts and/or to provide a membrane, which can regain its integrity after having been damaged.

The concept of self-healing structures has been known for many years and it has been successfully used, for example, in sealing of tire punctures.

WO 2010/070466 A1 discloses a waterproof lamination roof underlay with nail-hole sealing property, which is based on the use of a copolymer sealing layer composed of ethylene methyl acrylate thermoplastic resin between the other layers of a multiple waterproof roof underlay structure. The technical solution presented in WO 2010/070466 A1 is based on creeping of highly viscous sealing layer. This process is very slow and it requires elevated temperature and a pressure gradient, both of which may not be available when a leak in a roofing membrane has to be blocked. The method is also limited to sealing of gaps between intruding foreign objects, such as nails, and the body of the membrane but it is not suitable for sealing a hole in the membrane.

There thus remains a need for a membrane for use in waterproofing and roofing applications, which membrane is able to maintain its watertightness even in case of being damaged by punctures of sharp objects.

### SUMMARY OF THE INVENTION

The object of the present invention is to provide a sealing device for use in waterproofing and roofing applications exhibiting a self-healing property, which enables the sealing device to restore its watertightness after having been damaged by a sharp object dropped on its surface.

It has been surprisingly found out that a polymeric middle layer comprising at least one polymer and a specific amount of at least one powdered superabsorber polymer can be used for providing multi-layer sealing devices exhibiting self-healing properties. In particular it has been found out that a breach produced into such multilayer membrane will be partly or even fully closed after storing the polymeric layer only a couple of hours immersed in water. This has been found out to enable providing multilayer sealing devices, such as waterproofing and roofing membranes, which are able to restore their integrity after being damaged by a sharp object dropped on their surface due to the self-healing property of the middle polymeric layer.

Other subjects of the present invention are presented in other independent claims. Preferred aspects of the invention are presented in the dependent claims.

### BRIEF DESCRIPTION OF THE DRAWINGS

FIG. 1 shows a cross-section of a sealing device (1) comprising a first polymeric layer (2) having, a second polymeric layer (3), and a third polymeric layer (4), wherein the second polymeric layer (3) is located between the first and third polymeric layers (2, 4).

FIG. 2 shows a cross-section of a sealing device (1) according to an embodiment of the sealing device of FIG. 1, wherein the sealing device further comprises a first layer of fiber material (5) fully embedded into the first polymeric layer (2) and a second layer of fiber material (6) covering the second major surface of the third polymeric layer (4).

FIG. 3 shows a cross-section of a sealing device (1) of FIG. 1 in case of a damaged first polymeric layer (2).

FIG. 4 shows a cross-section of a State-of-the-Art three-layer membrane in case of a damaged first polymeric layer.

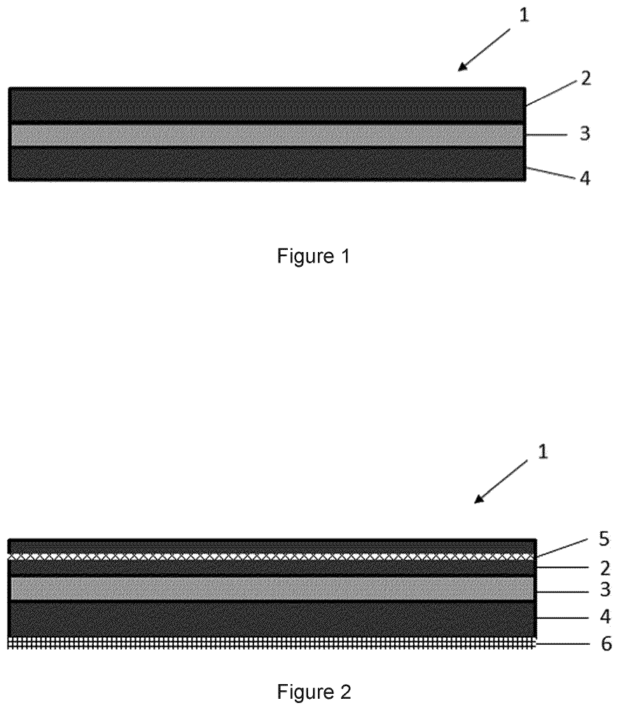

### DETAILED DESCRIPTION OF THE INVENTION

The subject of the present invention is a sealing device (1) comprising:

i. A first polymeric layer (2) comprising at least one first polymer P1 and

ii. A second polymeric layer (3) comprising at least one second polymer P2 and at least one powdered superabsorber polymer, and

iii. A third polymeric layer (4) comprising at least one third polymer P3, wherein the second polymeric layer (3) is located between the first polymeric layer (2) and the third polymeric layer (4) and wherein the at least one powdered superabsorber polymer comprises at least 15 wt.-%, preferably at least 20 wt.-% of the total weight of the second polymeric layer (3).

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “α-olefin” designates an alkene having the molecular formula CₓH2ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present disclosure.

The term “superabsorber polymer” or “super absorbent polymer” refers to special class of polymers that can absorb and retain extremely large amounts of a liquid relative to their own mass. For example, such a superabsorber polymer may be able to absorb up to 300 times its weight of water.

The term “molecular weight” refers to the molar mass (g/mol) of a molecule or a part of a molecule, also referred to as “moiety”. The term “average molecular weight” refers to number average molecular weight (Mₙ) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and tetrahydrofurane as a solvent, at a temperature of 35° C.

The term “melting temperature” refers to a temperature at which a material undergoes transition from the solid to the liquid state. The melting temperature (Tₘ) is preferably determined by differential scanning calorimetry (DSC) according to ISO 11357 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using a rheometer in torsional mode (with cyclic torsional load) with an applied frequency of 1 Hz and a strain level (amplitude) of 1%.

The term “softening point” refers to a temperature at which compound softens in a rubber-like state, or a temperature at which the crystalline portion within the compound melts. The softening point is preferably determined by Ring and Ball measurement conducted according to DIN EN 1238 standard.

The term “comonomer content of a copolymer” refers to the total amount of comonomers in the copolymer given in wt.-% or mol.-%. The comonomer content can be determined by IR spectroscopy or by quantitative nuclear-magnetic resonance (NMR) measurements.

The “amount or content of at least one component X” in a composition, for example “the amount of the at least one thermoplastic polymer” refers to the sum of the individual amounts of all thermoplastic polymers contained in the composition. For example, in case the composition comprises 20 wt.-% of at least one thermoplastic polymer, the sum of the amounts of all thermoplastic polymers contained in the composition equals 20 wt.-%.

The term “layer” refers to a sheet-like element having first and second major surfaces, i.e. top and bottom surfaces, defining a thickness there between, and a width defined between longitudinally extending edges. The term “thickness” refers to a dimension of a sheet-like element that is measured in a plane that is substantially perpendicular to the length and width dimensions of the element. Preferably the term “layer” refers to a sheet-like element having a length and width at least 5 times, preferably at least 25 times, more preferably at least 50 times greater than the thickness of the element.

The term “polymeric layer” refers to layer comprising a continuous phase composed of one or more polymers.

Preferably, the first and second polymeric layers are directly or indirectly connected to each other over at least part of their opposing major surfaces and the second and third polymeric layers are directly or indirectly connected to each other over at least part of their opposing major surfaces.

The polymeric layers can be indirectly connected to each other, for example, via a connecting layer, such as a layer of adhesive or via a layer of fiber material, or a combination thereof. In case a porous connecting layer, such as an open weave fabric, the polymeric layers may be partially directly connected and partially indirectly connected to each other over their opposing surfaces. The expression “directly connected” is understood to mean in the context of the present disclosure that no further layer or substance is present between the two layers and that the opposing surfaces of the two layers are directly bonded to each other or adhere to each other. At the transition area between the two directly connected layers, the materials forming the layers can also be present mixed with each other.

According to one or more embodiments, the first and second polymeric layers are directly connected to each other over at least part of their opposing major surfaces. According to one or more further embodiments, the second polymeric layer is directly connected over its substantially entire first major surface to the second major surface of the first polymeric layer. The expression “substantially entire surface” is understood to mean that at least 90%, preferably at least 95%, more preferably at least 97.5% of the area of the first major surface of the second polymeric layer is directly connected to the second major surface of the first polymeric layer.

According to one or more embodiments, the first and second polymeric layers have substantially same width and length and the second polymeric layer covers at least 75%, preferably at least 85%, more preferably at least 95%, even more preferably at least 97.5% of the area of the second major surface of the first polymeric layer.

According to one or more embodiments, the second and third polymeric layers have substantially same width and length and the third polymeric layer covers at least 75%, preferably at least 85%, more preferably at least 95%, even more preferably at least 97.5% of the area of the second major surface of the second polymeric layer.

The second polymeric layer comprises at least one powdered super absorber polymer, which is present in the second polymeric layer in an amount of at least 15 wt.-%, preferably at least 20 wt.-%, based on the total weight of the second polymeric layer. The “amount of the at least one powdered superabsorber polymer” in the second polymeric layer refers in the present disclosure to the amount of dry superabsorber polymer, i.e. to the amount of the at least one powdered superabsorber without the amount of water, which may be absorbed in the at least one powdered superabsorber polymer.

The self-healing effect obtained by using the second polymeric layer between the first and third polymeric layers is based on swelling of second polymeric layer after being contacted with water infiltrated through a breach in one of the other polymeric layers. The swelling of the second polymeric layer results from water being absorbed inside the superabsorber polymer particles contained in the second polymeric layer. The water absorption capacity of the second polymeric layer and on the other hand the amount of superabsorber particles in the second polymeric layer has to be high enough such that the swelling second polymeric layer fills the whole volume of the breach and forms a sealing plug against the infiltrating water.

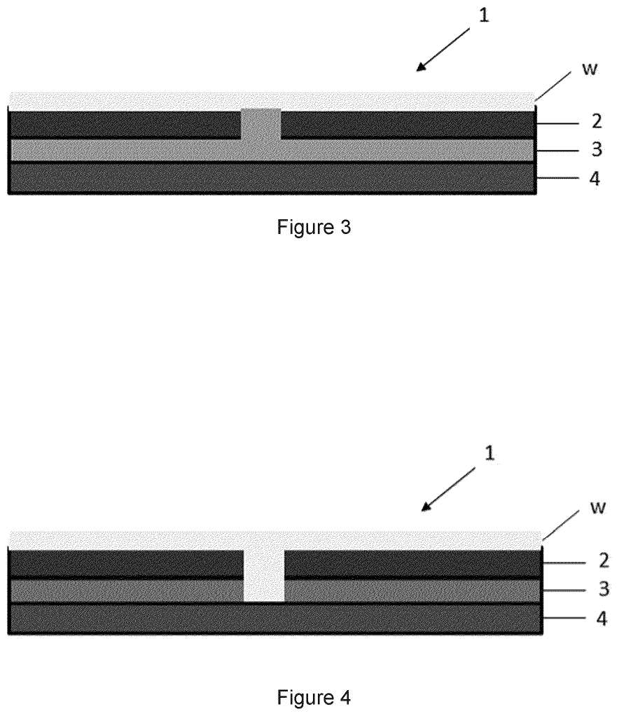

In case of a self-healing sealing device as presented in FIG. 3, the second polymeric layer (3) starts to swell after being contacted with water (w) leaking through a breach in the first polymeric membrane. The amount of swelling has to be sufficient to enable the second polymeric layer to fill the whole volume of the breach and to form a “sealing plug” against leaking water, as presented in FIG. 3. In case the water absorbing capacity of the second polymeric layer is too low, or in case of a State-of-the-Art three-layer waterproofing or roofing membrane, no sealing plug is formed and water can continue to flow through the breach of the first polymeric layer as presented in FIG. 4.

According to one or more embodiments, the at least one powdered superabsorber polymer comprises 20-60 wt.-%, preferably 25-50 wt.-%, more preferably 25-45 wt.-% of the total weight of the second polymeric layer (3).

According to one or more embodiments, the sum of the amounts of the at least one second polymer P2 and the at least one powdered superabsorber polymer is at least 40 wt.-%, preferably at least 45 wt.-%, more preferably at least 50 wt.-%, even more preferably at least 55 wt.-%, still more preferably at least 60 wt.-%, based on the total weight of the second polymeric layer.

The type of the at least one powdered superabsorber polymer present in the second polymeric layer is not particularly restricted. Suitable powdered superabsorber polymers include known homo- and co-polymers of (meth)acrylic acid, (meth)acrylonitrile, (meth)acrylamide, vinyl acetate, vinyl pyrrolidone, maleic acid, maleic anhydride, itaconic acid, itaconic anhydride, vinyl sulfonic acid or hydroxyalkyl esters of such acids, wherein 0-95% by weight of the acid groups have been neutralized with alkali or ammonium groups and wherein these polymers/copolymers are crosslinked by means of polyfunctional compounds. Suitable powdered superabsorber polymers are commercially available under the trade name of HySorb® (from BASF), under the trade name of FAVOR® and Creabloc® (both from Evonik Industries), and under the trade name of AQUALIC® CA (from Nippon Shokubai).

The at least one powdered super absorber preferably has a particle size, which enables it to be evenly distributed into the polymer matrix of the second polymeric layer. Preferably, the at least one powdered superabsorber polymer has a median particle size d₅₀ of not more than 1000 μm, more preferably not more than 750 μm, even more preferably not more than 600 μm, still more preferably not more than 500 μm.

According to one or more embodiments, the at least one powdered superabsorber polymer has a median particle size d₅₀ of not more than 150 μm, preferably not more than 125 μm, more preferably not more than 100 μm and/or a d₉₀ particle size of not more than 250 μm, preferably not more than 200 μm, more preferably not more than 175 μm.

The term “median particle size d₅₀” refers in the present disclosure to a particle size below which 50% of all particles by mass are smaller than the d₅₀ value whereas the term d₉₀ particle size refers in the present disclosure to a particle size below which 90% of all particles by mass are smaller than the d₉₀ value. The particle size distributions can be determined by sieve analysis according to the method as described in ASTM C136/C136M-14 standard (“Standard Test Method for Sieve Analysis of Fine and Coarse Aggregates).

The second polymeric layer is preferably not tacky to touch at a temperature of 23° C. Whether a layer material is “tacky to the touch” at a specific temperature can be easily determined by pressing the surface of the layer at the specific temperature with a finger. In doubtful cases, the “tackiness” can be determined by spreading powdered chalk on the surface of the layer at the specific temperature and subsequently tipping the surface so that the powdered chalk falls off. If the residual powdered chalk remains visibly adhering to the surface, the layer is considered tacky at the specific temperature.

According to one or more embodiments, the second polymeric layer has a loop tack adhesion to a glass plate measured at a temperature of 23° C. of not more than 1.0 N/25 mm, preferably not more than 0.5 N/25 mm, more preferably not more than 0.1 N/25 mm, even more preferably 0 N/25 mm. The loop tack adhesion can be measured using a “FINAT test method no. 9 (FTM 9) as defined in FINAT Technical Handbook, 9th edition, published in 2014.

According to one or more embodiments, the at least one first, second, and third polymers P1, P2, and P3 are selected from the group consisting of polyvinylchloride (PVC), ethylene—vinyl acetate copolymer (EVA), ethylene—acrylic ester copolymers, ethylene—α-olefin copolymers, propylene—α-olefin copolymers, polypropylene (PP), polyethylene (PE), polyethylene terephthalate (PET), polystyrene (PS), polyamides (PA), chlorosulfonated polyethylene (CSPE), ethylene propylene diene terpolymer rubber (EPDM), and polyisobutylene (PIB), preferably from the group consisting of polyvinylchloride (PVC), ethylene—vinyl acetate copolymer (EVA), ethylene—α-olefin copolymers, propylene—α-olefin copolymers, polypropylene (PP), polyethylene (PE), chlorosulfonated polyethylene (CSPE), and ethylene propylene diene monomer rubber (EPDM).

According to one or more embodiments, the at least one second polymer P2 is a thermoplastic polymer, preferably selected from the group consisting of polyvinylchloride (PVC), ethylene—vinyl acetate copolymer (EVA), ethylene—α-olefin copolymers, propylene—α-olefin copolymers, polypropylene (PP), polyethylene (PE), and chlorosulfonated polyethylene (CSPE). The term “thermoplastic” refers to a polymer material which can be melted at an elevated temperature and re-solidified by cooling with little or no change in physical properties.

According to one or more embodiments, the at least one first, second, and third polymers P1, P2, and P3 are thermoplastic polymers, preferably selected from the group consisting of polyvinylchloride (PVC), ethylene—vinyl acetate copolymer (EVA), ethylene—α-olefin copolymers, propylene—α-olefin copolymers, polypropylene (PP), polyethylene (PE), chlorosulfonated polyethylene (CSPE).

Suitable ethylene-α-olefin copolymers to be used as the at least one first, second, and third polymer P1, P2, and P3, include, for example, ethylene-α-olefin random and block copolymers of ethylene and one or more C₃-C₂₀ α-olefin monomers, in particular one or more of propylene, 1-butene, 1-pentene, 1-hexene, 1-heptene, 1-octene, 1-decene, 1-dodecene, and 1-hexadodecene, preferably comprising at least 50 wt.-%, more preferably at least 60 wt.-% of ethylene-derived units, based on the total weight of the copolymer.

Suitable propylene-α-olefin copolymers to be used as the at least one first, second, and third polymer P1, P2, and P3 include, for example, propylene-ethylene random copolymers and propylene-α-olefin random and block copolymers of propylene and one or more C₄-C₂₀ α-olefin monomers, in particular one or more of 1-butene, 1-pentene, 1-hexene, 1-heptene, 1-octene, 1-decene, 1-dodecene, and 1-hexadodecene, preferably comprising at least 50 wt.-%, more preferably at least 60 wt.-% of propylene-derived units, based on the total weight of the copolymer.

Suitable ethylene-α-olefin copolymers include, for example, ethylene-based polyolefin elastomers (POE), which are commercially available, for example, under the trade name of Engage®, such as Engage® 7256, Engage® 7467, Engage® 7447, Engage® 8003, Engage® 8100, Engage® 8480, Engage® 8540, Engage® 8440, Engage® 8450, Engage® 8452, Engage® 8200, and Engage® 8414 (all from Dow Chemical Company).

Other suitable ethylene-α-olefin copolymers include, for example, ethylene-based plastomers, which are commercially available, for example, under the trade name of Affinity®, such as Affinity® EG 81000, Affinity® EG 8200G, Affinity® SL 8110G, Affinity® KC 8852G, Affinity® VP 8770G, and Affinity® PF 1140G (all from Dow Chemical Company) and under the trade name of Exact®, such as Exact® 3024, Exact® 3027, Exact® 3128, Exact® 3131, Exact® 4049, Exact® 4053, Exact® 5371, and Exact® 8203 (all from Exxon Mobil).

Further suitable ethylene-α-olefin copolymers include ethylene-α-olefin block copolymers, such as ethylene-based olefin block copolymers (OBC), which are commercially available, for example, under the trade name of Infuse®, such as Infuse® 9100, Infuse® 9107, Infuse® 9500, Infuse® 9507, and Infuse® 9530 (all from Dow Chemical Company).

Suitable propylene-α-olefin copolymers include, for example, propylene based elastomers (PBE) and propylene-based plastomers (PBP), which are commercially available, for example, under the trade name of Versify® (from Dow Chemical Company) and under the trade name of Vistamaxx® (from Exxon Mobil).

Suitable copolymers of ethylene and vinyl acetate include those having a content of a structural unit derived from vinyl acetate in the range of 4-90 wt.-%, in particular 4-80 wt.-%, based on the total weight of the copolymer. Suitable copolymers of ethylene and vinyl acetate are commercially available, for example, under the trade name of Escorene® (from Exxon Mobil), under the trade name of Primeva® (from Repsol Quimica S.A.), and under the trade name of Evatane® (from Arkema Functional Polyolefins).

Thermoplastic olefin elastomers (TPE-O), which are also known as thermoplastic polyolefins (TPO), are also suitable for use as the at least one first, second, and third polymer P1, P2, and P3. TPOs are heterophase polyolefin compositions containing a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Commercially available TPOs include reactor blends of the base polyolefin and the polyolefin modifier, also known as “in-situ TPOs” or “impact copolymers (ICP)”, as well as physical blends of the aforementioned components. In case of a reactor-blend type of TPO, the components are typically produced in a sequential polymerization process, wherein the components of the matrix phase are produced in a first reactor and transferred to a second reactor, where the components of the dispersed phase are produced and incorporated as domains in the matrix phase. A physical-blend type of TPO is produced by melt-mixing the base polyolefin with the polyolefin modifier each of which was separately formed prior to blending of the components.

Particularly suitable TPOs to be used as the at least one first, second, and third polymer P1, P2, and P3 include the reactor-blend-type of thermoplastic polyolefins comprising polypropylene and/or propylene random copolymer as the high crystallinity base polyolefin and one or more ethylene copolymer(s), such as ethylene propylene-rubber (EPR), as the low-crystallinity or amorphous polyolefin modifiers.

Suitable commercially available reactor-blend-type thermoplastic polyolefins include, for example, the “reactor TPOs” produced with LyondellBasell's Catalloy process technology, which are available under the trade names of Adflex®, Adsyl®, Clyrell®, Hifax®, Hiflex®, and Soften®, such as such Hifax® CA 10A, Hifax® CA 12A, and Hifax® CA 212 A and the “random heterophasic copolymers”, which are commercially available under the trade name of Borsoft®, such as Borsoft® SD233 CF (from Borealis Polymers).

According to one or more embodiments, the at least one of the at least one first polymer P1 and the at least one third polymer P3 is a thermoplastic polyolefin (TPO), wherein the at least one first polymer P1 preferably comprises at least 35 wt.-%, more preferably at least 45 wt.-% of the total weight of the first polymeric layer and/or wherein the at least one third polymer P3 preferably comprises at least 35 wt.-%, more preferably at least 45 wt.-% of the total weight of the third polymeric layer and wherein the thermoplastic polyolefin (TPO) is preferably a reactor-blend-type thermoplastic polyolefin comprising polypropylene and/or propylene random copolymer as the high crystallinity base polyolefin and one or more ethylene copolymer(s), preferably ethylene propylene-rubber (EPR), as the low-crystallinity or amorphous polyolefin modifier.

According to one or more further embodiments, the at least one first polymer P1, the at least one second polymer P2, and the at least one third polymer P3 are thermoplastic polyolefins (TPO), wherein the thermoplastic polyolefin (TPO) is preferably a reactor-blend-type thermoplastic polyolefin comprising polypropylene and/or propylene random copolymer as the high crystallinity base polyolefin and one or more ethylene copolymer(s), preferably ethylene propylene-rubber (EPR), as the low-crystallinity or amorphous polyolefin modifier.

According to one or more embodiments, the thermoplastic polyolefin has:
a flexural modulus at 23° C., determined according to ISO 178 standard, of not more than 1500 MPa, preferably not more than 1000 MPa, more preferably not more than 750 MPa, even more preferably not more than 650 MPa, still more preferably not more than 600 MPa, most preferably not more than 550 MPa and/or
a xylene cold soluble content, determined according to ISO 16152-2005, of not more than 50 wt.-%, preferably not more than 45 wt.-%, more preferably not more than 40 wt.-%,even more preferably not more than 35 wt.-% and/or
a melt flow rate (2.16 kg at 230° C.), determined according to ISO 1133-1 standard, of not more than 50 g/10 min, preferably not more than 30 g/10 min, more preferably not more than 25 g/10 min, even more preferably not more than 15 and/or
a melting temperature (Tₘ), determined by DSC according to ISO 11357 standard using a heating rate of 2° C./min, of at least 100° C., preferably at least 110° C., more preferably at least 120° C., even more preferably at least 130° C.

The first and third polymeric layers can further comprise one or more additives, for example, UV- and heat stabilizers, fillers, antioxidants, flame retardants, pigments, dyes, matting agents, antistatic agents, impact modifiers, biocides, and processing aids such as lubricants, slip agents, antiblock agents, and denest aids. It is, however, preferred that the total amount of these types of auxiliary components is not more than 35 wt.-%, preferably not more than 25 wt.-%, more preferably not more than 20 wt.-%, even more preferably not more than 10 wt.-%, based on the total weight of the respective polymeric layers.

According to one or more embodiments, at least one of the at least one first polymer P1 and the at least one third polymer P3 is a polyvinylchloride resin, wherein the at least one first polymer P1 preferably comprises at least 25 wt.-%, more preferably at least 30 wt.-% of the total weight of the first polymeric layer and/or wherein the at least one third polymer P3 preferably comprises at least 25 wt.-%, more preferably at least 30 wt.-% of the total weight of the third polymeric layer.

According to one or more embodiments, the first and third polymeric layers are waterproofing layers, preferably having an impact resistance measured according to EN 12691: 2005 standard in the range of 200-1500 mm and/or a longitudinal and a transversal tensile strength measured at a temperature of 23° C. according to DIN ISO 527-3 standard of at least 5 MPa and/or a longitudinal and transversal elongation at break measured at a temperature of 23° C. according to DIN ISO 527-3 standard of at least 200% and/or a water resistance measured according to EN 1928 B standard of 0.6 bar for 24 hours and/or a maximum tear strength measured according to EN 12310-2 standard of at least 100 N.

According to one or more preferred embodiments, the first and third polymeric layers are polyvinylchloride-based waterproofing layers comprising:

a) 25-65 wt.-%, preferably 30-60 wt.-% of a polyvinylchloride resin, b) 15-50 wt.-%, preferably 20-40 wt.-% of at least one plasticizer, and c) 0-30 wt.-%, preferably 2.5-20 wt.-% of at least one mineral filler and/or at least one pigment, all proportions being based on the total weight of the polyvinylchloride-based waterproofing layer.

Preferably, polyvinylchloride resin has a K-value determined by using the method as described in ISO 1628-2-1998 standard in the range of 50-85, more preferably 65-75. The K-value is a measure of the polymerization grade of the PVC-resin and it is determined from the viscosity values of the PVC homopolymer as virgin resin, dissolved in cyclohexanone at 30° C.

Preferably, the composition of the polyvinylchloride-based waterproofing layer has a glass transition temperature (T_{g}), determined by dynamical mechanical analysis (DMA) using an applied frequency of 1 Hz and a strain level of 0.1%, of below −20° C., more preferably below −25° C.

The type of the at least one plasticizer is not particularly restricted in the present invention. Suitable plasticizers for the PVC-resin include but are not restricted to, for example, linear or branched phthalates such as di-isononyl phthalate (DINP), di-nonyl phthalate (L9P), diallyl phthalate (DAP), di-2-ethylhexyl-phthalate (DEHP), dioctyl phthalate (DOP), diisodecyl phthalate (DIDP), and mixed linear phthalates (911P). Other suitable plasticizers include phthalate-free plasticizers, such as trimellitate plasticizers, adipic polyesters, and biochemical plasticizers. Examples of biochemical plasticizers include epoxidized vegetable oils, for example, epoxidized soybean oil and epoxidized linseed oil and acetylated waxes and oils derived from plants, for example, acetylated castor wax and acetylated castor oil.

Particularly suitable phthalate-free plasticizers to be used in the waterproofing layer include alkyl esters of benzoic acid, dialkyl esters of aliphatic dicarboxylic acids, polyesters of aliphatic dicarboxylic acids or of aliphatic di-, tri- and tetrols, the end groups of which are unesterified or have been esterified with monofunctional reagents, trialkyl esters of citric acid, acetylated trialkyl esters of citric acid, glycerol esters, benzoic diesters of mono-, di-, tri-, or polyalkylene glycols, trimethylolpropane esters, dialkyl esters of cyclohexanedicarboxylic acids, dialkyl esters of terephthalic acid, trialkyl esters of trimellitic acid, triaryl esters of phosphoric acid, diary) alkyl esters of phosphoric acid, trialkyl esters of phosphoric acid, and aryl esters of alkanesulphonic acids.

According to one or more embodiments, the at least one plasticizer is selected from the group consisting of phthalates, trimellitate plasticizers, adipic polyesters, and biochemical plasticizers.

Suitable mineral fillers to be used in the polyvinylchloride-based waterproofing layer include, for example, sand, granite, calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present document to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as a mineral filler refers in the present document to calcitic fillers produced from chalk, limestone or marble by grinding and/or precipitation.

According to one or more embodiments, the at least one mineral filler is selected from the group consisting of calcium carbonate, diatomaceous earth, pumice, mica, kaolin, talc, dolomite, xonotlite, perlite, vermiculite, Wollastonite, barite, magnesium carbonate, silica, fumed silica, and fused silica.

Preferably, the at least one mineral filler has a median particle size d₅₀ of not more than 150 μm, more preferably not more than 100 μm, even more preferably not more than 75, still more preferably not more than 50 μm. According to one or more embodiments, the at least one mineral filler has a median particle size d₅₀ of 0.5-150 μm, preferably 1.5-100 μm, more preferably 2.5-50 μm, even more preferably 3.5-25 μm.

Suitable pigments to be used in the polyvinylchloride-based waterproofing layer include all types of inorganic and organic pigments. Suitable inorganic pigments to be used as the at least one pigment include, for example, titanium dioxide, in particular stabilized titanium dioxide.

The polyvinylchloride-based waterproofing layer can further comprise one or more additives, for example, UV- and heat stabilizers, antioxidants, flame retardants, dyes, matting agents, antistatic agents, impact modifiers, biocides, and processing aids such as lubricants, slip agents, antiblock agents, and denest aids. It is, however, preferred that the total amount of these types of auxiliary components is not more than 35 wt.-%, preferably not more than 25 wt.-%, more preferably not more than 15 wt.-%, even more preferably not more than 10 wt.-%, based on the total weight of the polyvinylchloride-based waterproofing layer.

According to one or more preferred embodiments, the first polymeric layer and the third polymeric layer are polyvinylchloride-based waterproofing layers as described above and the at least one second polymer P2 is a polyvinylchloride resin.

It was found out that the addition of the powdered superabsorber polymer to the polymer matrix of the second polymeric layer resulted in quite significant decrease of the mechanical properties of the second polymeric layer, in particular in terms of tensile strength and elongation at break. However, it was also found out that the negative influence of the powdered superabsorber polymer to the mechanical properties can at least partially be prevented by adding a compatibilizer to the second polymeric layer.

According to one or more embodiments, the second polymeric layer further comprises at least one compatibilizer selected from the group consisting of acid anhydride-functional polymers, chlorinated polyolefines, aminosilanes, and thermoplastic polyurethanes (TPU), preferably from the group consisting of aminosilanes and thermoplastic polyurethanes (TPU). Compatibilizers may be added to the second polymeric layer to improve the compatibility of the at least one powdered superabsorber polymer with the at least one second polymer P2. The use of such compatibilizers may be especially preferred in case the at least one second polymer P2 is a polyvinylchloride resin.

Suitable acid anhydride-functional polymers to be used as the at least one compatibilizer include polymers having an average of more than one acid anhydride group per molecule. Furthermore, suitable acid anhydride-functional polymer may contain either polymerized or grafted acid anhydride functionality, i.e. the acid anhydride moieties may be present as part of a polymer backbone or grafted onto a polymer as a side chain. Suitable acid anhydride-functional polymers include, in particular, maleic anhydride-functional polymers, for example, olefin maleic anhydride copolymers, olefin alkyl (meth)acrylate maleic anhydride terpolymers, maleic anhydride grafted polymers, and maleic anhydride grafted copolymers.

Particularly suitable acid anhydride-functional polymers to be used as the at least one compatibilizer include maleic anhydride grafted olefin vinyl acetate copolymers, maleic anhydride grafted ethylene-α-olefin copolymers, maleic anhydride grafted propylene-α-olefin copolymers, maleic anhydride grafted polyethylene, and maleic anhydride grafted polypropylene.

Suitable aminosilanes to be used as the at least one compatibilizer include, for example, primary aminosilanes such as 3 aminopropyltriethoxysilane, 3-aminopropyldiethoxymethylsilane; secondary aminosilanes such as N-butyl-3-aminopropyltriethoxysilane, N-phenyl-3-aminopropyltriethoxysilane; the products of the Michael-like addition of primary aminosilanes such as 3-aminopropyltriethoxysilane or 3-aminopropyldiethoxymethylsilane onto Michael acceptors such as acrylonitrile, (meth)acrylic esters, (meth)acrylamides, maleic diesters and fumaric diesters, citraconic diesters and itaconic diesters, examples being dimethyl and diethyl N-(3-triethoxysilylpropyl)aminosuccinate; and also analogs of the stated aminosilanes having methoxy or isopropoxy groups instead of the preferred ethoxy groups on the silicon.

The term “Michael acceptor” refers in the present document to compounds which on the basis of the double bonds they contain, activated by electron acceptor radicals, are capable of entering into nucleophilic addition reactions with primary amino groups (NH₂ groups) in a manner analogous to Michael addition (hetero-Michael addition).

Thermoplastic polyurethanes (TPU) is a class of polyurethane polymers, which are thermoplastic elastomers (TPE) consisting of linear segmented block copolymers composed of hard and soft segments. The proportion and type of hard and soft segments can be manipulated to produce a wide range TPUs having different hardness. The hard segments are isocyanates and can be classified as either aliphatic or aromatic depending on the type of isocyanate whereas the soft segments are made of a reacted polyol. Suitable thermoplastic polyurethanes to be used as the at least one compatibilizer are commercially available, for example, under the trade name of Estane (from Lubrizol Advanced Materials).

According to one or more embodiments, the at least one compatibilizer is present in the second polymer layer in an amount of not more than 30 wt.-%, preferably not more than 25 wt.-%, based on the total weight of the second polymeric layer.

Thermoplastic polyurethanes were found out to be most effective in improving the mechanical properties of the second polymeric layer, especially in case of a polyvinylchloride-based waterproofing layer.

According to one or more preferred embodiment, the at least one compatibilizer is a thermoplastic polyurethane (TPU), preferably having
a melt flow index determined according to ASTM D1238 standard (175° C., 2.16 kg) of not more than 25 g/10 min, preferably not more than 15 g/10 min and/or
a flexural modulus determined according to ASTM D790 standard of not more than 100 MPa, preferably not more than 50 MPa and/or
a Shore A hardness determined according to ASTM D2240 of at least 60, preferably at least 70.

According to one or more embodiments, the at least one compatibilizer is a thermoplastic polyurethane (TPU), which is present in the second polymer layer in an amount of 5-30 wt.-%, preferably 10-25 wt.-%, based on the total weight of the second polymeric layer.

According to one or more embodiments, the second polymeric layer is substantially free of tackifying resins. The term “tackifying resin” designates in the present disclosure resins that in general enhance the adhesion and/or tackiness of a composition. Typical tackifying resins include synthetic resins, natural resins, and chemically modified natural resins having a relatively low average molecular weight (Mₙ), such as not more than 3500 g/mol, in particular not more than 2500 g/mol. The expression “substantially free of tackifying resins” is understood to mean that the amount of tackifying resins is preferably less than 1.0 wt.-%, more preferably less than 0.5 wt.-%, even more preferably less than 0.1 wt.-%, still more preferably less than 0.05 wt.-%, most preferably 0.0 wt.-%, based on the total weight of the second polymeric layer.

According to one or more embodiment, the sealing device further comprises a layer of fiber material.

The term “fiber material” designates in the present document materials composed of fibers comprising or consisting of, for example, organic, inorganic or synthetic organic materials. Examples of organic fibers include, for example, cellulose fibers, cotton fibers, and protein fibers. Particularly suitable synthetic organic materials include, for example, polyester, homopolymers and copolymers of ethylene and/or propylene, viscose, nylon, and polyamides. Fiber materials composed of inorganic fibers are also suitable, in particular, those composed of metal fibers or mineral fibers, such as glass fibers, aramid fibers, wollastonite fibers, and carbon fibers. Inorganic fibers, which have been surface treated, for example, with silanes, may also be suitable. The fiber material can comprise short fibers, long fibers, spun fibers (yarns), or filaments. The fibers can be aligned or drawn fibers. It may also be advantageous that the fiber material is composed of different types of fibers, both in terms of geometry and composition.

Preferably, the layer of fiber material is selected from the group consisting of non-woven fabrics, woven fabrics, and laid scrims, more preferably from the group consisting of non-woven fabrics and laid scrims.

The term “non-woven fabric” refers in the present disclosure to materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric. Typical materials for the non-woven fabrics include synthetic organic and inorganic fibers.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim. Typical materials for laid scrims include metal fibers, inorganic fibers, in particular glass fibers, and synthetic organic fibers, in particular polyester, polypropylene, polyethylene, and polyethylene terephthalate (PET).

According to one or more embodiments, the layer of fiber material is a non-woven fabric composed of synthetic organic fibers or inorganic fibers, wherein the synthetic organic fibers are preferably selected from the group consisting of polyester fibers, polypropylene fibers, polyethylene fibers, nylon fibers, and polyamide fibers and wherein the inorganic fibers are selected from the group consisting of glass fibers, aramid fibers, wollastonite fibers, and carbon fibers and wherein the non-woven fabric preferably has a mass per unit weight of not more than 350 g/m², more preferably not more than 300 g/m², even more preferably not more than 250 g/m², such as in the range of 10-300 g/m², preferably 15-250 g/m². The mass per unit area of a non-woven fabric can be determined by measuring the mass of test piece of the non-woven fabric having a given area and dividing the measured mass by the area of the test piece. Preferably, the mass per unit area of a non-woven fabric is determined as defined in ISO 9073-18:2007 standard.

According to one or more further embodiments, the layer of fiber material is a laid scrim, preferably composed of synthetic organic fibers or glass fibers, wherein the synthetic organic fibers are preferably selected from the group consisting of polyester fibers, polypropylene fibers, polyethylene fibers, and polyethylene terephthalate (PET) fibers, more preferably polyester fibers.

The layer of fiber material can be at least partially embedded into at least one of the first, second, and third polymeric layers of the sealing device or adhesively adhered to at least one of the major surfaces of the aforementioned polymeric layers. The expression “at least partially embedded” is understood to mean that at least a portion of the fibers contained in the layer of fiber material are embedded into one or more of the aforementioned polymeric layers of the sealing device, i.e. covered by the matrix of one or more of the polymeric layers.

According to one or more embodiments, the sealing device comprises a first layer of fiber material and/or a second layer of fiber material, wherein the first layer of fiber material is preferably fully embedded into one of the first, second, and third polymeric layers of the sealing device and wherein the second layer of fiber material is partially embedded into at least one of the first, second, and third polymeric layers of the sealing device or adhesively adhered to at least one of the major surfaces of the aforementioned polymeric layers. One example of a sealing device according to these embodiments is shown in FIG. 2. The expression “fully embedded” is understood to mean that the layer of fiber material is fully covered by the matrix of one of the respective polymeric layer of the sealing device.

According to one or more embodiment, the first layer of fiber material is a laid scrim, preferably composed of synthetic organic fibers or glass fibers, wherein the synthetic organic fibers are preferably selected from the group consisting of polyester fibers, polypropylene fibers, polyethylene fibers, and polyethylene terephthalate (PET) fibers and the second layer of fiber material is a non-woven fabric composed of synthetic organic fibers or inorganic fibers, wherein the synthetic organic fibers are preferably selected from the group consisting of polyester fibers, polypropylene fibers, polyethylene fibers, nylon fibers, and polyamide fibers and wherein the inorganic fibers are selected from the group consisting of glass fibers, aramid fibers, wollastonite fibers, and carbon fibers and wherein the non-woven fabric preferably has a mass per unit weight of not more than 350 g/m², more preferably not more than 300 g/m², even more preferably not more than 250 g/m², such as in the range of 10-300 g/m², preferably 15-250 g/m².

According to one or more embodiments, the second layer of fiber material has been thermally laminated to one of the major surfaces of the third polymeric layer, such as to the second major surface of the third polymeric layer, in a manner that gives direct bonding between the second layer of fiber material and the third polymeric layer. The term “thermal lamination” refers in the present disclosure to a process, in which the layers are bonded to each by the application of thermal energy. In particular, the term “thermal lamination” refers to a process comprising partially melting at least one of the layers upon application of thermal energy followed by a cooling step, which results in formation of a physical bond between the layers without using an adhesive.

It can also be advantageous that the sealing device further comprises a top-coating covering at least a portion of the first major surface of the first polymeric layer. The top-coating may comprise UV-absorbers and/or thermal stabilizers to protect the sealing device from damaging influence of sunlight. The top-coating may also comprise color pigments in order to provide the sealing device with a desired color.

According to one or more embodiments, the second polymeric layer has a thickness determined according to the DIN EN 1849-2 standard in the range of 0.1-1.5 mm, preferably 0.2-1.0, more preferably 0.3-0.8 mm and/or the sealing device has a total thickness determined according to the DIN EN 1849-2 standard in the range of 0.75-5.0 mm, preferably 1.0-3.5 mm, more preferably 1.0-2.5 mm, even more preferably 1.0-2.0 mm.

There are no particular limitations for the width and length of the sealing device and the first, second, and third polymeric layers and these depend on the intended use of the sealing device. For example, the sealing device can be provided in form of a narrow strip having a width, for example, in the range of 10-500 mm, such as 50-350 mm, in particular 75-250 mm. These types of sealing devices are suitable for use, for example, as sealing tapes. Furthermore, the sealing device can also be provided in form of a membrane having a width, for example, in the range of 750-3000 mm, such as 1000-2500 mm, in particular 1000-2000 mm. These types of sealing devices are suitable for use, for example, as roofing and waterproofing membranes.

The preferences given above for the first, second, and third polymeric layers, and to the at least one layer of fiber material apply equally to all subjects of the present invention unless stated otherwise.

Another subject of the present invention is a method for producing a sealing device according to the present invention, the method comprising steps of:

i) Extruding or co-extruding melt-processed compositions of the polymeric layers and

ii) Bonding the extruded polymeric layers to each other.

Step i) of the method can be conducted using a suitable extrusion apparatus comprising at least one extruder, for example, a ram extruder, single screw extruder, a twin-screw extruder or a planetary roller extruder, and at least one extruder die. Such extrusion apparatuses are well known to a person skilled in the art. The melt-processed compositions of the polymeric layers are preferably obtained by melt-processing starting compositions comprising the constituents of the respective polymeric layer. The melt-processing is preferably conducted using an extruder, such as a single or twin-screw extruder or a planetary roller extruder.

The extruded polymeric layers can be bonded to each other, for example, by thermal lamination or by using an adhesive. The term “thermal lamination” refers here to a process comprising partially melting at least one of the layers upon application of thermal energy followed by a cooling step, which results in formation of a bond between the layers without using a bonding agent, such as an adhesive.

According to one or more embodiments, step i) of the method for producing a sealing device comprises co-extruding a melt-processed compositions of the first, second, and third polymeric layer through a common extruder die, preferably a flat die, using a co-extrusion apparatus. In these embodiments it may be preferable that the co-extrusion apparatus comprises a first extruder for melt-processing of a first starting composition comprising the constituents of the first polymeric layer, a second extruder for melt-processing of a second starting composition comprising the constituents of the second polymeric layer, and a third extruder for melt-processing of a third starting composition comprising the constituents of the third polymeric layer. The common extruder die is preferably equipped with a single- or a multi-manifold. The constituents of the polymeric layers may be fed to the extruder as individual streams, as a pre-mix, a dry blend, or as a master batch. The co-extruded polymeric layers can be bonded to each other, for example, by employing spaced apart calender cooling rolls through which the extruded shaped melt composite is drawn subsequently to step i).

Another subject of the present invention is a method for covering a substrate, the method comprising steps of:

I) Applying a first and a second sealing device according to the present invention onto the surface of the substrate to be covered,

II) Overlapping an edge region of the second sealing device over an overlapped section of an upper side of the first sealing device,

III) Bonding the opposing surfaces of the edge region and the overlapped section to each other by using heat-welding or adhesive bonding means.

According to one or more embodiments, the substrate that is covered with the sealing devices is a roof substrate, preferably an insulation board, a cover board, or an existing roofing membrane.

According to one or more further embodiments, the method for covering a substrate comprises bonding the opposing surfaces of the edge region and the overlapped section to each other by using heat-welding means, wherein step III) comprises:

III′) Heating the edge region of the second sealing device and the overlapped section of the first sealing device above the melting temperature of the composition of the third and first polymeric layers, respectively, and

III″) Bonding the opposing surfaces of the edge region and the overlapped section to each other under sufficient pressure to provide acceptable seam strength without use of an adhesive.

Steps III′) and III″) of the method for covering a substrate can be conducted manually, for example by using a hot air tool, or by using an automatic welding device, such as an automatic hot-air welding device, for example Sarnamatic® 661 welding device. The temperature to which the edge region of the second sealing device and the overlapped section of the first sealing device are heated depends on the embodiment of the first and second sealing devices and also whether the steps III′) and III″) are conducted manually or by using an automatic welding device. Preferably, the edge region of the second sealing device and the overlapped section of the first sealing device are heated to a temperature of at or above 150° C., more preferably at or above 200° C., even more preferably of at or above 250° C.

Still another subject of the present invention is a waterproofed structure obtained by using the method for covering a substrate of the present invention.

### EXAMPLES

The followings materials were used in the examples:

TABLE 1

| | | |
|---|---|---|
| PVC | Polyvinylchloride resin K70 | Ivonyn |
| Plasticizer | DINP | Evonik Industries |
| Thermal stabilizer | Lead free stabilizer | Chemson Group |
| Pigment | TiO₂ | Kronos |
| Filler | Chalk | Omya |
| Superabsorber | BASF Hysorb T 6600 | BASF |
| Aminosilane | KH550 | Zhejiang Feidian |
| | | Chemical Co., Ltd |
| CPE | Chlorinated polyethylene | Weifang Yaxing |
| | (PE) | Chemical Co., Ltd |
| TPU | Estane ALR CL87A-V | Lubrizol |

### Preparation of Membranes

Polymer compositions of the top (first), middle (second), and bottom (third) polymeric layers were first melt-processed separately in a two roll mill and then pressed into sheets having a thickness of ca. 0.6 mm each, using a laboratory curing press at a temperature of 190° C. and using a pressing time of 3 minutes and a pressure of 120 bar. After cooling of the individual layers, three layer membrane samples were prepared by stacking top, middle, and bottom layer and pressing the layers together using the laboratory press at a temperature of 190° C. using a pressing time of 3 minutes at a pressure of 10 bar.

The superabsorber having originally an average particle size of ca. 500 μm was milled with a Fritch Pulverisette 14′ rotation mill to an average particle size of ca. 100 μm before being mixed with the other constituents of the middle polymeric layer.

The compositions of the top and bottom layer are shown in Table 2 and the compositions of the reference (Ref) and inventive (Ex) compositions of the middle layer are shown in Tables 3 and 4.

TABLE 2

| Composition [wt.-%] | Top layer | Bottom layer |
|---|---|---|
| PVC | 53.76 | 55.56 |
| Plasticizer | 34.95 | 36.11 |
| Thermal stabilizer | 2.69 | 2.78 |
| Pigment | 8.60 | 0.00 |
| Filler | 0.00 | 5.56 |
| Total | 100.00 | 100.00 |

### Tensile Strength and Elongation at Break

Tensile strength and elongation at break were measured according to ISO 527-3:2018 standard at a temperature of 21° C. using a Zwick tensile tester and a cross head speed of 100 mm/min.

Table 3 shows the tensile strength of the three-layer membranes prepared as described above whereas the values for tensile strength and elongation at break shown in Table 4 are obtained with single-layer membranes composed of the prepared middle layer only. The values of tensile strength and elongation at break were obtained as an average of five measurements using sample strips, which were cut from the respective three-layer or single-layer membranes in a lengthwise direction. The values obtained with the sample membranes of examples Ex-7 to Ex-13 presented in Table 4 indicate that the mechanical properties of the middle layer can be improved by addition of a compatibilizer in the polymer matrix of the middle layer.

### Self-Healing Property

The three-layer membranes prepared according to the procedure as described above were tested for their self-healing properties. Each tested membrane was first damaged by puncturing the membrane with a screw driver resulting in a hole having a diameter of ca. 3 mm and reaching through the top layer of the membrane. The damaged membranes were then immersed in water for different periods of time after which the self-healing effect, i.e. closing of the hole in the damaged membrane, was evaluated by visual means. The results of the self-healing test for the three-layer membranes are shown in Table 3.

TABLE 3

| Composition [wt.-%] | | Ref-1 | Ex-2 | Ex-3 | Ex-4 | Ex-5 | Ex-6 |
|---|---|---|---|---|---|---|---|
| PVC | | 53.76 | 48.39 | 43.01 | 37.63 | 32.26 | 26.88 |
| Plasticizer | | 34.95 | 31.45 | 27.96 | 24.46 | 20.97 | 17.47 |
| Thermal stab | | 2.69 | 2.42 | 2.15 | 1.88 | 1.61 | 1.34 |
| Pigment | | 8.60 | 7.74 | 6.88 | 6.02 | 5.16 | 4.30 |
| SAP | | 0.00 | 10.00 | 20.00 | 30.00 | 40.00 | 50.00 |
| Total | | 100.00 | 100.00 | 100.00 | 100.00 | 100.00 | 100.00 |
| Tensile strength at | | 13.6 | 12.5 | 10.8 | 9.8 | 9.1 | 5.5 |
| break [N/mm2] | | | | | | | |
| Self sealing after | | | | | | | |
| 30 | min | no | no | no | no | no | no |
| 1 | h | no | no | no | no | yes | yes |
| 2 | h | no | no | yes | yes | yes | yes |
| 3 | h | no | no | yes | yes | yes | yes |

TABLE 4

| Composition [wt.-%] | Ref-2 | Ex-7 | Ex-8 | Ex-9 | Ex-10 | Ex-11 | Ex-12 | Ex-13 |
|---|---|---|---|---|---|---|---|---|
| PVC | 53.76 | 37.63 | 37.63 | 36.54 | 34.95 | 32.26 | 29.57 | 26.88 |
| Plasticizer | 34.95 | 24.46 | 24.46 | 23.75 | 22.72 | 20.97 | 19.22 | 17.47 |
| Thermal stab | 2.69 | 1.88 | 1.88 | 1.83 | 1.75 | 1.61 | 1.48 | 1.34 |
| Pigment | 8.60 | 6.02 | 6.02 | 5.85 | 5.59 | 5.16 | 4.73 | 4.30 |
| SAP | 0.00 | 30.00 | 27.27 | 26.48 | 30.00 | 30.00 | 30.00 | 30.00 |
| KH550 | 0.00 | 0.00 | 2.73 | 2.65 | 0.00 | 0.00 | 0.00 | 0.00 |
| CPE | 0.00 | 0.00 | 0.00 | 2.91 | 0.00 | 0.00 | 0.00 | 0.00 |
| TPU | 0.00 | 0.00 | 0.00 | 0.00 | 5.00 | 10.00 | 15.00 | 20.00 |
| Total | 100.00 | 100.00 | 100.00 | 100.00 | 100.00 | 100.00 | 100.00 | 100.00 |
| Tensile strength at | 15.3 | 7.8 | 10.0 | 8.7 | 7.8 | 8.9 | 9.6 | 11.2 |
| break [N/mm2] | | | | | | | | |
| Elongation at break [%] | 282 | 163 | 82 | 93 | 170 | 219 | 238 | 275 |

1. A sealing device comprising:
i. a first polymeric layer comprising at least one first polymer P1 and
ii. a second polymeric layer comprising at least one second polymer P2 and at least one powdered superabsorber polymer, and
iii. a third polymeric layer comprising at least one third polymer P3, wherein
the second polymeric layer is located between the first polymeric layer and the third polymeric layer and wherein the at least one powdered superabsorber polymer comprises at least 15 wt.%, of the total weight of the second polymeric layer.

2. The sealing device according to claim 1, wherein the at least one powdered superabsorber polymer comprises 20-60 wt. % of the total weight of the second polymeric layer.

3. The sealing device according to claim 1, wherein the sum of the amounts of the at least one second polymer P2 and the at least one powdered superabsorber polymer is at least 40 wt.-%, based on the total weight of the second polymeric layer.

4. The sealing device according to claim 1, wherein the at least one powdered superabsorber polymer has a median particle size d₅₀ of not more than 1000 μm.

5. The sealing device according to claim 1, wherein the second polymeric layer is not tacky to touch at a temperature of 23° C.

6. The sealing device according to claim 1, wherein the at least one first, second, and third polymers P1, P2, and P3 are selected from the group consisting of polyvinylchloride ethylene—vinyl acetate copolymer, ethylene—α-olefin copolymers, propylene—α-olefin copolymers, polypropylene, polyethylene, chlorosulfonated polyethylene, and ethylene propylene diene monomer rubber.

7. The sealing device according to claim 1, wherein the at least one second polymer P2 is a thermoplastic polymer, selected from the group consisting of polyvinylchloride, ethylene—vinyl acetate copolymer, ethylene—α-olefin copolymers, propylene—α-olefin copolymers, polypropylene, polyethylene, and chlorosulfonated polyethylene.

8. The sealing device according to claim 1, wherein the first polymeric layer and the third polymeric layer are polyvinylchloride-based waterproofing layers.

9. The sealing device according to claim 8, wherein the polyvinylchloride-based waterproofing layer comprises:
a) 25-65 wt.-% of a polyvinylchloride resin,
b) 15-50 wt.-% of at least one plasticizer, and
c) 0-30 wt.-% of at least one mineral filler and/or at least one inorganic pigment, all proportions being based on the total weight of the waterproofing layer.

10. The sealing device according to claim 1, wherein the at least one second polymer P2 is polyvinyl chloride resin.

11. The sealing device according to claim 1, wherein the second polymeric layer further comprises at least one compatibilizer selected from the group consisting of acid anhydride-functional polymers, chlorinated polyolefines, aminosilanes, and thermoplastic polyurethanes, and wherein the at least one compatibilizer is present in the second polymer layer in an amount of not more than 30 wt.-%, based on the total weight of the second polymeric layer.

12. The sealing device according to claim 11, wherein the at least one compatibilizer is a thermoplastic polyurethane, having a melt flow index determined according to ASTM D1238 standard (175° C., 2.16 kg) of not more than 25 g/10 min, and/or a flexural modulus determined according to ASTM D790 standard of not more than 100 MPa, and/or Shore A hardness determined according to ASTM D2240 of at least 60.

13. The sealing device according to claim 12, wherein the at least one compatibilizer is present in the second polymer layer in an amount of 5-30 wt.-%, based on the total weight of the second polymeric layer.

14. The sealing device according to claim 1, wherein the second polymeric layer has a thickness determined according to the DIN EN 1849-2 standard in the range of 0.1-1.5 mm, and/or wherein the sealing device has a total thickness determined according to the DIN EN 1849-2 standard in the range of 0.75-5.0 mm.

15. A method for producing a sealing device according to claim 1, the method comprising steps of:
i) extruding or co-extruding melt-processed compositions of the first, second, and third polymeric layers and
ii) bonding the extruded polymeric layers to each other.

16. A method for covering a substrate comprising steps of:
I) applying a first and a second sealing device according to claim 1 onto the surface of the substrate to be covered,
II) overlapping an edge region of the second sealing device over an overlapped section of an upper side of the first sealing device,
III) bonding the opposing surfaces of the edge region and the overlapped section to each other by using heat-welding or adhesive bonding means.
